(19) United States
(12) Patent Application Publication
(10) Pub. No.: US 2003/0190549 A1
(43) Pub. Date: Oct. 9, 2003

(54) Photosensitive composition

(75) Inventor: Takahiro Goto, Shizuoka-ken (JP)

Correspondence Address: SUGHRUE MION, PLLC, 2100 Pennsylvania Avenue, NW, Washington, DC, 20037-3213, US

(73) Assignee: FUJI PHOTO FILM CO., LTD.

(21) Appl. No.: 10/357,497

(22) Filed: Feb. 4, 2003

(30) Foreign Application Priority Data
Feb. 5, 2002 (JP) 2002-28144
Dec. 18, 2002 (JP) 2002-366205

(51) Int. Cl. B32B 9/04

(52) U.S. Cl. 430/270.1; 430/944

(57) ABSTRACT

The invention provides an infrared sensitive composition included in an image recording material having a support and a photosensitive layer disposed on the the support, the infrared sensitive composition being contained in the photosensitive layer, wherein after the photosensitive layer has been formed and the infrared sensitive composition is exposed to an infrared laser, the infrared sensitive composition has an insolubilization rate within a range of 30% to 100% with respect to a mixed organic solvent containing methylethyl ketone and dimethyl-sulfoxide in a ratio of 1:1.

### BACKGROUND OF THE INVENTION

1. Field of the Invention

The present invention relates to a photopolymerizable composition hardenable by exposure to infrared light, and more particularly to an infrared sensitive composition adapted for use in a recording layer of a negative printing plate precursor.

2. Description of the Related Art

Various systems for making a printing plate directly from digital data in a computer have been developed, and, for example, an image recording material based on a photopolymerization system to be exposed by a laser emitting blue or green visible light is attracting attention as an image recording layer (hereinafter also suitably called “photosensitive layer”) of a planographic printing plate capable of achieving a long press life due to a high strength of a coated film hardened by photopolymerization, since such a material is sensitive, for example, to an argon laser and enables high-speed direct platemaking utilizing a photopolymerization initiating system.

As an example of a laser printing plate utilizing a photopolymerization initiating system sensitive to a visible light emitting laser such as an argon laser, a printing plate including, on an aluminum plate as a support, a layer of a photopolymerizable composition which comprises a compound containing an ethylenic double bond and capable of addition polymerization, and a photopolymerization initiator, and which may further comprise if desired an organic polymer binder, a thermal polymerization inhibitor and the like, and an oxygen intercepting layer disposed thereon for intercepting oxygen which inhibits the polymerization, is known. In such photopolymerizable planographic printing plate, imagewise exposure of a desired image is conducted to polymerize and harden an exposed portion, and an unexposed portion is eliminated (developed) with an aqueous alkali solution to form an image on the printing plate.

Owing to recent remarkable advances in laser technology, solid-state lasers and semiconductor lasers emitting an infrared light within a wavelength region of 760 nm to 1200 nm have become readily available with high output power and a compact size. Such lasers are extremely useful as a recording light source for direct platemaking from digital data in a computer or the like. For this reason, in addition to the various photosensitive recording materials having a sensitive wavelength in the practically useful visible light region not exceeding 760 nm, materials recordable with such infrared lasers are being developed.

Among the materials selectively sensitive to infrared light, there are known image recording materials of a positive type and a negative type. As an image recording materials of the positive type, Japanese Patent Application Laid-open (JP-A) No. 9-43847 discloses a material utilizing a phase change of a novolac resin, but such a material is poor in scratch resistance and is insufficient in handlability. On the other hand, as image recording materials of the negative type which are superior in scratch resistance, JP-A No. 6-1088, JP-A No. 9-43845 and others disclose materials that do not require pre-heating, but such materials have a problem in that image quality, particularly a dot reproduction, is inferior.

### SUMMARY OF THE INVENTION

An object of the present invention is to provide an infrared-sensitive composition hardenable by an infrared laser, adapted for use as an image recording layer of a negative printing plate precursor capable of direct recording from digital data such as from a computer, and capable of forming an image which is excellent in dot reproduction.

The above-mentioned objective has been attained as explained in the following. More specifically, the invention is configured as follows.

A first embodiment of the present invention is an infrared sensitive composition included in an image recording material comprising a support and a photosensitive layer disposed on the the support, the infrared sensitive composition being contained in the photosensitive layer, wherein after the photosensitive layer has been formed and the infrared sensitive composition is exposed to an infrared laser, the infrared sensitive composition has an insolubilization rate within a range of 30% to 100% with respect to a mixed organic solvent containing methylethyl ketone and dimethyl-sulfoxide in a ratio of 1:1.

A second embodiment of the present invention is, an infrared sensitive composition according to the first embodiment, wherein the insolubilization rate is within a range of 35% to 100%

A third embodiment of the present invention is an infrared sensitive composition according to the first embodiment, wherein the insolubilization rate is within a range of 60% to 100%.

A fourth embodiment of the present invention is an infrared sensitive composition according to the first embodiment, wherein the photosensitive layer exposed to the infrared laser is hardened only in an upper layer portion thereof.

A fifth embodiment of the present invention is an infrared sensitive composition according to the first embodiment, including an infrared absorber, wherein the infrared absorber is at least one selected from the group of dyes and pigments having an absorption maximum within a wavelength range of 760 nm to 1200 nm.

A sixth embodiment of the present invention is an infrared sensitive composition according to the fifth embodiment, wherein the infrared absorber is a dye including a compound represented by the following general formula (I):

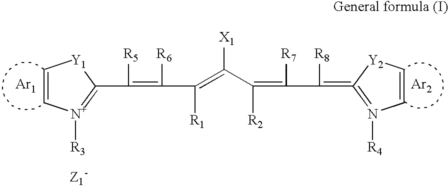

wherein X₁ represents a halogen atom or X₂-L₁ in which X₂ represents an oxygen atom or a sulfur atom and L₁ represents a hydrocarbon group having 1 to 12 carbon atoms; R₁ and R₂ each independently represent a hydrocarbon group having 1 to 12 carbon atoms; Ar₁ and Ar₂ each independently represent an aromatic hydrocarbon group which may have a substituent; Y₁ and Y₂ each independently represent a sulfur atom or a dialkylmethylene group having 12 or less carbon atoms; R₃ and R₄ each independently represent a hydrocarbon group having 20 or less carbon atoms which may have a substituent; R₅, R₆, R₇ and R₈ each independently represent a hydrogen atom or a hydrocarbon group having 12 or less carbon atoms; and Z₁⁻ represents a counter anion but may be dispensed with if any of R₁ to R₈ has a sulfo group as a substituent.

A seventh embodiment of the present invention is an infrared sensitive composition according to the fifth embodiment, wherein the photosensitive layer including the infrared absorber has an optical density within a range of 0.1 to 3.0 at the absorption maximum within a wavelength range of 760 nm to 1200 nm.

A eighth embodiment of the present invention is an infrared sensitive composition according to the first embodiment, including an onium salt.

A ninth embodiment of the present invention is an infrared sensitive composition according to the eighth embodiment, wherein the onium salt is at least one compound selected from the group of compounds represented by the following general formulae (III) to (V):

Ar₁₁—I⁺—Ar₁₂Z₁₁⁻ General formula (III)

Ar₂₁—N⁺≡N⁺Z₂₁⁻ General formula (IV)

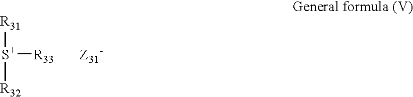

wherein, in the formula (III), Ar₁₁ and Ar₁₂ each independently represent an aryl group having 20 or less carbon atoms which may have a substitutent; and Z₁₁⁺ represents a counter ion selected from the group consisting of a halogen ion, a perchlorate ion, a tetrafluoroborate ion, a hexafluorophosphate ion, a carboxylate ion and a sulfonate ion;

in the formula (IV), Ar₂₁ represents an aryl group having 20 or less carbon atoms which may have a substituent; and Z₂₁⁻ represents a counter ion of the same definition as Z₁₁^{; and}

in the formula (V), R₃₁, R₃₂ and R₃₃ each independently represent a hydrocarbon group having 20 or less carbon atoms which may have a substituent; and Z₃₁⁻ represents a counter ion of the same definition as Z₁₁⁻.

A tenth embodiment of the present invention is an infrared sensitive composition according to the eighth embodiment, wherein the photosensitive layer is formed by coating a photosensitive layer coating solution including the above-mentioned infrared sensitive composition, and the onium salt is contained in an amount of 0.1% to 50% by weight with respect to a total solid content of the photosensitive layer coating solution.

A eleventh embodiment of the present invention is an infrared sensitive composition according to the eighth embodiment, wherein the photosensitive layer is formed by coating a photosensitive layer coating solution including the above-mentioned infrared sensitive composition, and the onium salt is contained in an amount of 1 to 20% by weight with respect to a total solid content of the photosensitive layer coating solution.

A twelfth embodiment of the present invention is an infrared sensitive composition according to the first embodiment, including a compound containing at least one ethylenic unsaturated double bond.

A thirteenth embodiment of the present invention is an infrared sensitive composition according to the first embodiment, including a compound containing two or more terminal ethylenic unsaturated double bonds.

A fourteenth embodiment of the present invention is an infrared sensitive composition according to the first embodiment, wherein the infrared laser is at least one of a solid-state laser and a semiconductor laser, emitting light within a wavelength range of 760 nm to 1200 nm.

A fifteenth embodiment of the present invention is an infrared sensitive composition according to the first embodiment, wherein an amount of exposure by the infrared laser is within a range of 10 to 300 mJ/cm².

A sixteenth embodiment of the present invention is an infrared sensitive composition according to the first embodiment, including a linear organic polymer.

A seventeenth embodiment of the present invention is an infrared sensitive composition according to the sixteenth embodiment, wherein the linear organic polymer is at least one selected from the group of a water-soluble polymer, a alkalescent water-soluble polymer, a water-swellable polymer and a alkalescent water-swellable polymer.

A eighteenth embodiment of the present invention is an infrared sensitive composition according to the sixteenth embodiment, wherein the linear organic polymer has a weight-averaged molecular weight within a range of 10,000 to 300,000.

A nineteenth embodiment of the present invention is an infrared sensitive composition according to the sixteenth embodiment, wherein the linear organic polymer is a random polymer.

A twentieth provided an infrared sensitive composition according to the first embodiment, including an unsaturated bond containing compound containing at least one ethylenic unsaturated double bond, and a linear organic polymer, and a ratio (b/a) of a weight of the added unsaturated bond-containing compound (b) to a weight of the linear organic polymer (a) is within a range of 1/9 to 7/3.

### DESCRIPTION OF THE PREFERRED EMBODIMENTS

The present invention will be explained in detail below.

A layer formed by coating an infrared sensitive composition of the invention on a support can be advantageously used as an image recording layer having photosensitivity, and, after the coating and being subjected to irradiation with an infrared laser, the infrared sensitive composition is required to have an insolubilization rate within a range of 30% to 100% with respect to an organic solvent specified below.

In the invention, the insolubilization rate with respect to the organic solvent is defined by immersing the image recording layer, including the infrared sensitive composition, of the image recording material in a mixed organic solvent of methylethyl ketone and dimethylsulfoxide (weight ratio 1/1) for 5 minutes at 25° C., measuring a weight change rate before and after exposure, and calculating a value [(weight change amount before exposure−weight change amount after exposure)/(weight change amount before exposure)].

More specifically, the weight change amount after exposure is determined as follows. At first, the image recording layer is coated over a coating area and with a coating amount which are the same as when the recording layer is actually used, an 8 cm×12 cm sample of the formed layer is cut off, and a weight of the sample is measured (hereinafter called “weight 1”). Then, the sample of the image recording layer, having been subjected to exposure with the infrared laser, is immersed in 1 liter of the above-described mixed organic solvent with respect to the coating amount of the image recording layer for 5 minutes at 25° C., and a weight of the sample is measured (hereinafter called “weight 2”). A difference obtained by subtracting the weight 2 from the weight 1 is referred to as the “weight change rate after exposure”. In the above-mentioned immersion, the solvent is allowed to stand still without agitation.

Similarly, the weight change amount before exposure is determined as follows. The image recording layer is coated over a coating portion and with a coating amount same which are the same as when the recording layer is actually used, an 8 cm×12 cm sample of the formed layer is cut off, and a weight of the sample is measured (hereinafter called “weight 3”). Then, the image recording layer is subjected to immersion under the same conditions as described above without undergoing exposure with the infrared laser, and a weight of the sample is measured (hereinafter called “weight 4”). A difference obtained by subtracting the weight 4 from the weight 3 is referred to as the “weight change rate before exposure”.

The insolubilization rate is obtained according to a following equation (I):

[(weight change amount before exposure−weight change amount after exposure)/(weight change amount before exposure)]×100.

The insolubilization rate with respect to the specified organic solvent constitutes an index for progress of photopolymerization after exposure, With a higher insolubilization rate, a formed image becomes stronger, and, when an image recording material is formed, a press life and dot reproduction thereof are superior. The insolubilization rate is preferably within a range of 35% to 100%, and more preferably from 60% to 100%. An insolubilization rate less than 30% is not practically acceptable because of a deterioration of dot reproduction.

For improving the insolubilization rate, there can be employed, for example, a method of regulating a kind and an amount of a compound relating to the film hardening in the infrared sensitive composition, for example a radical generating agent or a radical polymerizable compound.

Also, for a given infrared sensitive composition, it is possible to improve the insolubilization rate for example by a method of regulating the exposure amount of the infrared laser. More specifically, even in case of employing an infrared sensitive composition that cannot achieve the insolubilization rate of the invention under a normal exposure, the insolubilization rate of the invention may be attained by increasing the exposure amount of the infrared laser.

By crosslinking using light, the exposed photosensitive layer may be hardened uniformly or only in an upper layer portion of the exposed photosensitive layer, but it is particularly preferable that only an upper layer portion of the photosensitive layer is hardened. If only the upper layer portion of the photosensitive layer is hardened, a lower layer portion of the photosensitive layer is not hardened by crosslinking, but rather is soluble in a developer, whereby an image with a better sharpness can be formed. However, such a situation does not mean that the lower layer portion of the exposed photosensitive layer is not crosslinked at all. The lower layer portion is crosslinked to a lesser degree than the upper layer portion, whereby the lower layer portion is more soluble in the developer than the upper layer portion.

An image recording material including a photosensitive layer capable of showing such crosslinked state is preferred for use in a planographic printing plate, as it can provide a sharp printed image with a high resolution. Such crosslinked state can be attained also by regulating a kind and an amount of an infrared absorber, in addition to the radical generating agent and the radical polymerizable compound mentioned in the foregoing. More specifically, an increase in the amount of the infrared absorber increases a photothermal converting efficiency at an exposed surface, thereby causing an efficient hardening process but suppresses the hardening in a deeper portion of the film because an optical transmission of the entire film is lowered.

The preferred infrared sensitive composition of the invention includes (A) an infrared light absorber, (B) a radical generating agent, (C) a radical polymerizable compound, and preferably (D) a binder polymer. These components will be explained in succession in the following.

(A) Infrared Absorber

An objective of the invention is to record an image with a laser emitting an infrared light, and the use of an infrared absorber is essential. The infrared absorber to be employed in the invention is a dye or a pigment, having an absorption maximum in a wavelength region of 760 nm to 1200 nm.

For the dye, there can be employed commercially available dyes and known ones described for example in “Senryo Binran (Dye Handbook)” (edited by Organic Synthetic Chemical Society, 1970). Specific examples of such dye include azo dyes, metal complex azo dyes, pyrazolone azo dyes, naphthoquinone dyes, anthraquinone dyes, phthalocyanine dyes, carbonium dyes, quinonimine dyes, methine dyes, cyanine dyes, squalirium dyes, pyrilium salts, and metal thiolate complexes.

Preferred dyes include cyanine dyes described in JP-A Nos. 58-125246, 59-84356, 59-202829 and 60-78787, methine dyes described in JP-A Nos. 58-173696, 58-181690 and 58-194595, naphthoquinone dyes described in JP-A Nos. 58-112793, 58-224793, 59-48187, 59-73996, 60-52940 and 60-63744, squalirium dyes described in JP-A No. 58-112792 and cyanine dyes described in BP No. 434,875.

There can also be advantageously employed a near infrared absorption sensitizer described in U.S. Pat. No. 5,156,938, and there can be preferably employed substituted arylbenzo(thio)pyrilium salts described in U.S. Pat. No. 3,881,924, trimethinethiapyrilium salts described in JP-A No. 57-142645 (U.S. Pat. No. 4,327,169), pyrilium compounds described in JP-A Nos. 58-181051, 58-220143, 59-41363, 59-84248, 59-84249, 59-146063 and 59-146061, cyanine dyes described in JP-A No. 59-216146, pentamethinethiopyrilium salts described in U.S. Pat. No. 4,283,475 and pyrilium compounds described in JP-B No. 5-13514 and 5-19702.

Also other preferred examples of the dye are near infrared absorbing dyes described in U.S. Pat. No. 4,756,993 by formulas (I) and (II).

Among these dyes, particularly preferred are cyanine dyes, squalirium dyes, pyrilium salts, and nickel thiolate complexes. Further, more preferred are cyanine dyes, and most preferred is a cyanine dye represented by a following general formula (I):

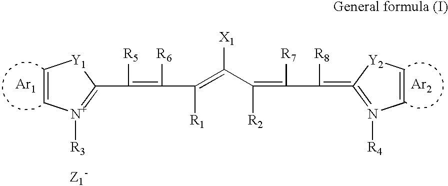

In the general formula (I), X₁ represents a halogen atom or X₂-L₁ in which X₂ represents an oxygen atom or a sulfur atom and L₁ represents a hydrocarbon group having 1 to 12 carbon atoms. R₁ and R₂ each independently represent a hydrocarbon group of 1 to 12 carbon atoms. In consideration of stability in storage of the photosensitive layer coating solution, each of R₁ and R₂ is preferably a hydrocarbon group having 2 or more carbon atoms, and more preferably R₁ and R₂ are mutually bonded to form a five-membered ring or a six-membered ring.

Ar₁ and Ar₂, which may be same or different, each represent an aromatic hydrocarbon group which may have a substituent. Preferred examples of the aromatic hydrocarbon group include a benzene ring and a naphthalene ring. Also preferred examples of the substituent include a hydrocarbon group having 12 or less carbon atoms, a halogen atom, and an alkoxy group with 12 or less carbon atoms. Y₁ and Y₂, which may be same or different, each represent a sulfur atom or a dialkylmethylene group having 12 or less carbon atoms. R₃ and R₄, which may be same or different, each represent a hydrocarbon group with 20 or less carbon atoms, which may have a substituent. Preferred examples of the substituent include an alkoxy group having 12 or less carbon atoms, a carboxyl group and a sulfo group. R₅, R₆, R₇ and R₈, which may be same or different, each represent a hydrogen atom, or a hydrocarbon group having 12 or less carbon atoms. Hydrogen atom is preferred because of the availability of the raw material. Z₁⁺ represents a counter anion. However, Z₁⁻ is not required in case any of R₁ to R₈ is substituted with a sulfo group. In consideration of the stability in storage of the photosensitive layer coating solution, Z₁⁻ is preferably a halogen ion, a perchlorate ion, a tetrafluoroborate ion, a hexafluorophosphate ion, or a sulfonate ion, and more preferably a perchlorate ion, a hexafluorophosphate ion or an arylsulfonate ion.

Specific examples of the cyanine dyes represented by the general formula (I) and advantageously employable in the invention are described in paragraphs [0017] to [0019] of JP-A No. 2001-133969 (Japanese Patent Application No. 11-310623).

Examples of the pigment employable in the invention include commercially available pigments and pigments described in Color Index (C. I.), “Saishin Ganryo Binran (Latest Pigment Handbook)” (Pigment Technology Society of Japan, 1977), “Saishin Ganryo Ouyou Gijutsu (Latest Pigment Application Technology)” (CMC Press, 1986), and “Insatsu Ink Gijutsu (Printing Ink Technology)” (CMC Press, 1984).

The type of the pigment can be a black pigment, a yellow pigment, an orange pigment, a brown pigment, a red pigment, a purple pigment, a blue pigment, a green pigment, a fluorescent pigment, a metal power pigment, or a polymer bonded pigment. Specific examples include insoluble azo pigments, azo rake pigments, condensed azo pigments, chelate azo pigments, phthalocyanine pigments, anthraquinone pigments, perylene and perynone pigments, thioindigo pigments, quinachrydone pigments, dioxazine pigments, isoindolinone pigments, quinophthalone pigments, vat rake pigments, azine pigments, nitroso pigments, nitro pigments, natural pigments, fluorescent pigments, inorganic pigments and carbon black, among which preferred is carbon black.

These pigments may be used with or without a surface treatment. The surface treating method can be, for example, a method of surface coating with resin or wax, a method of adhering a surfactant, or a method of bonding a reactive substance (for example a silane coupling agent, an epoxy compound or polyisocyanate) to the pigment surface. These surface treating methods are described in “Kinzoku Sekken no Seishitsu to Ouyou (Properties and Applications of Metal Soaps)” (Saiwai Shobo), “Insatsu Ink Gijutsu (Printing Ink Technology)” (CMC Press, 1984) and “Saishin Ganryo Ouyou Gijutsu (Latest Pigment Application Technology)” (CMC Press, 1986).

The particle size of the pigment is preferably within a range of 0.01 to 10 μm, more preferably 0.05 to 1 μm and most preferably 0.1 to 1 μm. A particle size of the pigment less than 0.01 μm is undesirable in the stability of dispersion in the photosensitive layer coating solution, and a particle size exceeding 10 μm is undesirable in the uniformity of the photosensitive layer.

For dispersing the pigment, there can be used a known dispersion technology employed in ink manufacture or toner manufacture. A dispersing machine can be an ultrasonic dispersing device, a sand mill, an Atliter, a pearl mill, a super mill, a ball mill, an impeller, a disperser, a KD mill, a colloid mill, a dynatron, a three-roll mill or a pressurized kneader. Details are described in “Saishin Ganryo Ouyou Gijutsu (Latest Pigment Application Technology)” (CMC Press, 1986).

Such infrared absorber may be added in a same layer including other components or in a separate layer, but, in the preparation of a negative printing plate precursor, the photosensitive layer preferably has an optical density within a range of 1.0 to 3.0 at the absorption maximum within the wavelength range of 760 nm to 1200 nm. A value outside such range tends to result in a lowered sensitivity. As the optical density is determined by the amount of addition of the infrared absorber and the thickness of the image recording layer, a desired optical density can be obtained by controlling both parameters. The optical density of the image recording layer can be measured by an ordinary method. The measurement can be achieved, for example, by forming, on a transparent or white support, an image recording layer of a thickness suitably determined within a range of a dry coating amount required for the planographic printing plate, and executing a measurement with a transmission optical densitometer, or by forming an image recording layer on a reflective support such as of aluminum or the like and measuring a reflection density.

(B) Radical Generating Agent

The radical generating agent to be employed in the invention is a compound capable of generating radicals when used in combination with the infrared absorber and irradiated with the infrared laser. The radical generating agent can be, for example, an onium salt, a triazine compound having a trihalomethyl group, a peroxide, an azo polymerization initiator, an azide compound or a quinonediazide, but an onium salt is preferred because of a high sensitivity. In the following there will be given an explanation on the onium salt advantageously employable in the invention. A preferred onium salt can be a iodonium salt, a diazonium salt or a sulfonium salt. In the invention, such onium salt functions not as an acid generator but as a radical polymerization initiator. The onium salt advantageously employable in the invention is represented by following general formulas (III) to (V):

Ar₁₁—I⁺—Ar₁₂Z₁₁⁻ General formula (III)

Ar₂₁—N⁺≡N⁺Z₂₁⁻ General formula (IV)

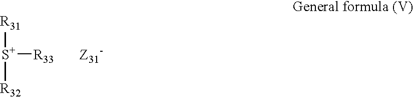

In the formula (III), Ar¹¹ and Ar¹² each independently represent an aryl group having 20 or less carbon atoms which may have a substitutent. In case the aryl group has a substituent, preferred examples of the substituent include a halogen atom, a nitro group, an alkyl group having 12 or less carbon atoms, an alkoxy group having 12 or less carbon atoms, and an aryloxy group with 12 or less carbon atoms. Z¹¹⁻ represents a counter ion selected from the group of a halogen ion, a perchlorate ion, a tetrafluoroborate ion, a hexafluorophosphate ion, a carboxylate ion and a sulfonate ion, and is preferably a perchlorate ion, a hexafluorophosphate ion, a carboxylate ion or an arylsulfonate ion.

In the formula (IV), Ar²¹ represents an aryl group having 20 or less carbon atoms which may have a substituent. Preferred examples of the substituent include a halogen atom, a nitro group, an alkyl group having 12 or less carbon atoms, an alkoxy group with 12 or less carbon atoms, an aryloxy group having 12 or less carbon atoms, an alkylamino group having 12 or less carbon atoms, a dialkylamino group having 12 or less carbon atoms, an arylamino group having 12 or less carbon atoms, and a diarylamino group group having 12 or less carbon atoms. Z²¹⁻ represents a counter ion of the same definition as Z¹¹⁻.

In the formula (V), R³¹, R³² and R³³, which may be same or different and may be substituted, each independently represent a hydrocarbon group having 20 or less carbon atoms. Preferred examples of the substituent include a halogen atom, a nitro group, an alkyl group having 12 or less carbon atoms, an alkoxy group having 12 or less carbon atoms, and an aryloxy group having 12 or less carbon atoms. Z³¹⁻ represents a counter ion of the same definition as Z¹¹⁻.

Specific examples of the onium salt advantageously employable in the invention as the radical generating agent are described in paragraphs [0030] to [0033] of JP-A No. 2001-133969.

The radical generating agent to be employed in the invention preferably has a maximum absorption wavelength not exceeding 400 nm, more preferably not exceeding 360 nm. The absorption wavelength in such ultraviolet region allows to handle the printing plate precursor under a white light.

Such radical generating agent can be added to the photosensitive layer coating solution in an amount within a range of 0.1 wt. % to 50 wt. % with respect to the total solids of the photosensitive layer coating solution, preferably 0.5 wt. % to 30 wt. % and more preferably 1 wt. % to 20 wt. %. An amount of addition less than 0.1 wt. % results in a lowered sensitivity, while an amount of addition exceeding 50 wt. % results in a stain in a non-image portion at a printing operation. These radical generating agents may be used singly or in a combination of two or more kinds. Also the radical generating agent may be added to a same layer including other components, or to another layer provided separately.

(C) Radical Polymerizable Compound

The radical polymerizable compound to be employed in the invention is selected from radical polymnerizable compounds having at least an ethylenic unsaturated double bond, and including at least one, and preferably two or more, terminal ethylenic unsaturated bonds. Such compounds are widely known in the related industrial field, and may be employed in the invention without any particular limitation. Such compounds have a chemical structure of a monomer, a prepolymer namely a dimer, a trimer or an oligomer, or a mixture thereof or a copolymer thereof. Examples of the monomer and the copolymer thereof include an unsaturated carboxylic acid (such as acrylic acid, methacrylic acid, itaconic acid, crotonic acid, isocrotonic acid or maleic acid), an ester thereof and an amide thereof, and there is preferably employed an ester of an unsaturated carboxylic acid and an aliphatic polyhydric alcohol, or an amide of an unsaturated carboxylic acid and an aliphatic polyvalent amine. An unsaturated carboxylic acid ester or amide having a nucleophilic substituent such as a hydroxyl group, an amino group or a mercapto group, an addition product of the ester or amide with a monofunctional or polyfunctional isocyanate or epoxy compound, or a dehydration condensation product of the ester or amide with a monofunctional or polyfunctional carboxylic acid can also be preferably employed. An unsaturated carboxylic acid ester or amide having an electrophilic substituent such as an isocyanate group or an epoxy group, an addition product of the ester or amide with a monofunctional or polyfunctional alcohol, amine, or thiol are also preferable. Further an unsaturated carboxylic acid ester or amide having a cleavable substituent such as a halogen group or a tosyloxy group, or a substitution reaction product of the ester or amide with a monofunctional or polyfunctional alcohol, amide or thiol are also preferable. As other examples, compounds in resulting from replacing which the above-mentioned unsaturated carboxylic acid with an unsaturated phosphonic acid or a styrene in the examples discribed above can also be employed.

Within the radical polymerizable compound constituted by an ester of an aliphatic polyhydric alcohol and an unsaturated carboxylic acid, specific examples of an acrylic acid ester, a methacrylic acid ester, an itaconic acid ester, a crotonic acid ester, an isocrotonic acid ester and a maleic acid ester are described in paragraphs [0037] to [0042] of JP-A No. 2001-133969, and these compounds are also applicable in the invention.

Other examples of the ester advantageously employable include aliphatic alcohol esters described in JP-B Nos. 46-27926 and 51-47334 and JP-A No. 57-196231, those having an aromatic skeleton described in JP-A Nos. 59-5240, 59-5241 and 2-226149, and those having an amino group described in JP-A No. 1-165613.

Also specific examples of the monomer constituted by an amide of an aliphatic polyvalent amine and an unsaturated carboxylic acid include methylenebis-acrylamide, methylenebis-methacrylamide, 1,6-hexamethylenebis-acrylamide, 1,6-hexamethylenebis-methcarylamide, diethylenetriamine trisacrylamide, xylilenebisacrylamide and xylilenebismethacrylamide.

Examples of another preferred amide monomer include those having a cyclohexylene structure described in JP-B No. 54-21726.

Also there is advantageously employed an urethane addition polymerizable compound which is prepared by an addition reaction of an isocyanate and a hydroxyl group, and specific examples of such compound include a vinylurethane compound having two or more polymerizable vinyl groups in a molecule, and prepared by adding a vinyl monomer having a hydroxyl group and represented by a following formula (VI) to a polyisocyanate compound having two or more isocyanate groups in a molecule, as described in JP-B No. 48-41708:

CH₂═C(R⁴¹)COOCH₂CH(R⁴²)OH General formula (VI)

wherein R⁴¹ and R⁴² each represent H or CH₃.

Furthermore, there can be advantageous employed an urethane acrylate described in JP-A No. 51-37193, JP-B Nos. 2-32293 and 2-16765, and an urethane compound having an ethylene oxide skeleton described in JP-B Nos. 58-49860, 56-17654, 62-39417 and 62-39418.

Furthermore, there may also be employed a radical polymerizable compound having an amino structure or a sulfide structure in a molecule, as described in JP-A Nos. 63-277653, 63-260909 and 1-105238.

Still other examples include a polyfunctional acrylate or methacrylate such as a polyester acrylate or an epoxy acrylate formed by reacting an epoxy resin and (meth)acrylic acid as described in JP-A No. 48-64183, JP-B Nos. 49-43191 and 52-30490. Still other examples include a specified unsaturated compound as described in JP-B Nos. 46-43946, 1-40337 and 1-40336, and a vinylphosphonic acid compound described in JP-A No. 2-25493. Also in certain cases, there is advantageous employed a structure including a perfluoroalkyl group described in JP-A No. 61-22048. Also there can be employed photocurable monomers and oligomers introduced in Nippon Secchaku Kyokai-Shi (Bulletin of Japanese Adhesive Society), vol. 20, No. 7, pp300-308 (1984).

With respect to such radical polymerizable compound, details of method of use, such as a selection of a structure, whether the compound is used singly or in a combination, an amount of addition can be arbitrarily selected according to the designing of a performance of a final recording material. For example, such details are selected on following viewpoints. With respect to a sensitivity, there is preferred a structure including a larger number of unsaturated groups per molecule, and the presence of two or more functional groups is preferred in most cases. Also in order to increase the strength of an image portion, namely a hardened film, the presence of three or more functional groups is advantageous, and it is also effective to regulate both the sensitivity and the strength by employing compounds having different numbers of functional groups and different kind of polymerizable groups (for example acrylic acid ester compounds, methacrylic acid ester compounds, and styrenic compounds). A compound with a high molecular weight or a high hydrophobicity is excellent in the sensitivity and in the film strength, but may be undesirable in consideration of a developing speed or a precipitation in the developer. Also the selection of the radical polymerizable compound and the method of use thereof are important factors also for a compatibility with and a dispersibility in other components (for example a binder polymer, an initiator, and a coloring agent) in the photosensitive layer, and the compatibility may be improved for example by employing a compound of a lower purity or two or more compounds in combination. Also there may be selected a specified structure for the purpose of improving adhesion to a support or an overcoat layer. A higher composition ratio of the radical polymerizable compound in the image recording layer is advantageous for the sensitivity, but an excessively high composition ratio may result in drawbacks such as an undesirable phase separation, a trouble in a manufacturing process resulting from tackiness of the image recording layer (for example a defect resulting from a transfer or an adhesion of a component of the image recording layer), or a precipitation from the developer. Based on these considerations, a preferred composition ratio of the radical polymerizable compound is, in most cases, within a range of 5 to 80 wt. % with respect to all the components of the composition, more preferably 20 to 75 wt. %. The radical polymerizable compound may be used singly or in a combination of two or more kinds. Also, in the method of using the radical polymerizable compound, a suitable structure, a composition and an addition amount can be arbitrarily selected in consideration of a magnitude of polymerization inhibition by oxygen, a resolution, a level of fogging, a change in the refractive index, a surface tackiness property and the like, and in certain cases there may also be employed a layer structure or a coating method involving an undercoating and/or an overcoating.

(D) Binder Polymer

In the infrared sensitive composition of the present invention, there may be further employed, if necessary, a binder polymer for example for improving film properties of the image recording layer to be formed. For such binder, a linear organic polymer is preferably employed. For such “linear organic polymer”, there can be arbitrarily employed any known one. Preferably there is selected a linear organic polymer which is soluble or swellable in water or in alkalescent water, in order to enable a development with water or alkalescent water. The linear organic polymer is selected not only as a film forming substance for forming the photosensitive layer, but also according to a purpose of use by development with water, alkalescent water or an organic solvent. For example, a development with water is made possible by using a water-soluble organic polymer. Such linear organic polymer can be a radical polymerized product having a carboxylic acid group in a side chain, for example compounds described in JP-A No. 59-44615, JP-B Nos. 54-34327, 58-12577 and 54-25957, JP-A Nos. 54-92723, 59-53836 and 59-71048, such as a methacrylic acid copolymer, an acrylic acid copolymer, an itaconic acid copolymer, a crotonic acid copolymer, a maleic acid copolymer or a partially esterified maleic acid copolymer. There is also known an acidic cellulose derivative having a carboxylic acid group in a side chain. In addition, an addition product of a cyclic acid anhydride to a polymer having a hydroxyl group is also useful.

Among these, a (meth)acrylic resin having a benzyl group or an allyl group and a carboxyl group in a side chain is particularly advantageous in consideration of a balance of the film strength, the sensitivity and the development performance.

Also an urethane binder polymer including an acid group, described for example in JP-B Nos. 7-12004, 7-120041, 7-120042 and 8-12424, JP-A Nos. 63-287944, 63-287947, 1-271741 and 10-116232, is excellent in the strength and is therefore advantageous for improving the press life and the performance for a low exposure amount.

Also as the water-soluble linear organic polymer, polyvinylpyrrolidone or polyethylene oxide is useful. Also for improving the strength of the cured film, alcohol-soluble nylon or a polyether compound reacted by 2,2-bis-(4-hydroxyphenyl)-propane and epichlorohydrin is useful.

The polymer to be employed in the invention has a weight-averaged molecular weight preferably of 5,000 or higher, more preferably within a range from 10,000 to 300,000, and a number-averaged molecular weight preferably of 1,000 or higher and more preferably within a range from 2,000 to 250,000. A degree of polydispersity (weight-averaged molecular weight/number-averaged molecular weight) is preferably 1 or higher, more preferably within a range from 1 to 10.

Such polymer can be a random polymer, a block polymer, or a graft polymer, but is preferably a random polymer.

The polymer to be employed in the invention can be synthesized by an already known method. A solvent to be employed in the synthesis can be, for example, tetrahydrofurane, ethylene dichloride, cyclohexanone, methylethyl ketone, acetone, methanol, ethanol, ethyleneglycol monomethyl ether, ethyleneglycol monoethyl ether, 2-methoxyethyl acetate, diethyleneglycol dimethyl ether, 1-methoxy-2-propanol, 1-methoxy-2-propyl acetate, N,N-dimethylformamide, N,N-dimethylacetamide, toluene, ethyl acetate, methyl lactate, ethyl lactate, dimethylsulfoxide or water. Such solvent may be used singly or as a mixture of two or more kinds.

As a radical polymerization initiator to be used in synthesizing the polymer to be employed in the invention, there can be employed a known compound such as an azo initiator or a peroxide initiator.

The binder polymer to be employed in the invention may be used singly or as a mixture of two or more kinds. Such polymer is added to the photosensitive layer in an amount of 20 to 95 wt. % with respect to the total solids of the photosensitive layer coating solution, preferably 30 to 90 wt. %. An amount of addition less than 20 wt. % results in an insufficient strength of an image portion in the image formation. Also with an amount of addition exceeding 95 wt. %, an image formation is not possible. Also an addition ratio (b/a) of the radical polymerizable compound (b) having the ethylenic unsaturated double bond to the linear organic polymer (a) is preferably within a range of 1/9 to 7/3 in a weight ratio.

Other Components of Photosensitive Layer

In the invention, other various compounds may be added according to the necessity. For example, a dye having a large absorption in the visible wavelength region may be used as a coloring agent for the image. Specific examples include oil yellow #101, oil yellow #103, oil pink #312, oil green BG, oil blue BOS, oil blue #603, oil black BY, oil black BS, oil black T-505 (foregoing manufactured by Orient Kagaku Kogyo Co., Ltd.), Victoria pure blue, crystal violet (CI42555), methyl violet (CI42535), ethyl violet, rhodamine B (CI145170B), marachite green (C142000), methylene blue (CI52015), and dyes described in JP-A No. 62-293247. Also there can be advantageously employed a pigment such as a phthalocyanine pigment, an azo pigment, carbon black or titanium oxide.

Addition of such coloring agent is preferred, as an image portion and a non-image portion can be easily distinguished after image formation. An amount of addition is within a range of 0.01 to 10 wt. % with respect to the total solids of the photosensitive layer coating solution.

In the present invention, in order to prevent an unnecessary thermal polymerization of the radical polymerizable compound having the ethylenic unsaturated double bond during the preparation or the storage of the photosensitive layer coating solution, it is desirable to add a small amount of a thermal polymerization inhibitor. Examples of the suitable thermal polymerization inhibitor include hydroquinone, p-methoxyphenol, di-t-butyl-p-cresol, pyrogarol, t-butylcatechol, benzoquinone, 4,4′-thiobis(3-methyl-6-t-butylphenol), 2,2′-methnylenebis(4-methyl-6-t-butylphenol) and N-nitroso-N-phenylhydroxylamine aluminum salt. An addition amount of the thermal polymerization inhibitor is preferably about 0.01 to 5 wt. % with respect to the weight of the entire composition. Also, if necessary in order to prevent inhibition of polymerization by oxygen, a higher fatty acid derivative such as behenic acid or behenic acid amide may be added and made to be present locally at the surface of the photosensitive layer in the course of a drying step after coating. An addition amount of such higher fatty acid derivative is preferably about 0.1 to 10 wt. % with respect to the entire composition.

In the photosensitive layer coating solution of the invention, for widening the stability of processing in developing conditions, there may be added a nonionic surfactant as described in JP-A Nos. 62-251740 and 3-208514, or an amphoteric surfactant as described in JP-A Nos. 59-121044 and 4-13149.

Specific examples of the nonionic surfactant include sorbitan tristearate, sorbitan monopalmitate, sorbitan trioleate, stearic acid monoglyceride, and polyoxyethylene nonylphenyl ether.

Specific examples of amphoteric surfactant include alkyldi(aminoethyl)glycine, alkylpolyaminoethylglycine hydrochloride, 2-alkyl-N-carboxyethyl-N-hydroxyethylimidazolinium betain and N-tetradecyl-N,N-betaine (for example “Amogen K” (trade name), manufactured by Dai-ichi Kogyo Seiyaku Co., Ltd.).

The proportion of the nonionic surfactant and amphoteric surfactant in the photosensitive layer coating solution is preferably 0.05 to 15 wt. %, and more preferably 0.1 to 5 wt. %.

In addition, other additives such as an adhesion promoter, a development accelerator, an ultraviolet absorber, and a slipping agent may be suitably added according to the purpose.

Also in the photosensitive layer coating solution of the invention, a plasticizer is added if necessary in order to provide a flexibility in the coated film. For example there can be employed polyethylene glycol, tributyl citrate, diethyl phthalate, dibutyl phthalate, dihexyl phthalate, dioctyl phthalate, tricresyl phosphate, tributyl phosphate, trioctyl phosphate, or tetrahydrofurfuryl oleate.

A printing plate precursor can be produced with the infrared sensitive composition of the invention, by dissolving, in a solvent, the above-described components necessary for the photosensitive layer coating solution and by coating such solution on a suitable support. Examples of the solvent to be used include ethylene dichloride, cyclohexanone, methylethyl ketone, methanol, ethanol, propanol, ethyleneglycolmonomethyl ether, 1-methoxy-2-propanol, 2-methoxyethyl acetate, 1-methoxy-2-propyl acetate, dimethoxyethane, methyl lactate, ethyl lactate, N,N-dimethylacetamide, N,N-dimethylformamide, tetramethyl-urea, N-methylpyrrolidone, dimethylsulfoxide, sulfolane, γ-butyrolactone, toluene, and water but these examples are not restrictive. These solvents may be used singly or in a mixture thereof. The concentration of aforementioned components (all solids including the additives) in the solvent is preferably 1 to 50 wt. %.

Also the coating amount (solid) of the photosensitive layer obtained on the support after coating and drying is variable depending on the purpose of use, but, for a printing plate precursor, there is generally preferred a range of 0.5 to 5.0 g/m². The coating can be achieved by various methods, such as bar coater coating, spin coating, spray coating, curtain coating, immersion coating, air knife coating, blade coating or roller coating. With a decrease in the coating amount, the apparent sensitivity increases but film characteristics of the photosensitive layer serving for image recording are lowered.

In the photosensitive layer coating solution of the invention, there may be added a surfactant for improving the coating property, for example a fluorochemical surfactant as described in JP-A No. 62-170950. An amount of addition with respect to the total solids of the photosensitive layer is preferably 0.01 wt. % to 1 wt. %, more preferably 0.05 wt. % to 0.5 wt. %.

Support

The negative image recording material, utilizing the infrared sensitive composition of the invention, is formed by coating the aforementioned photosensitive layer on a support. The employable support is not particularly limited as long as it is a dimensionally stable plate-shaped member and can be, for example, paper, paper laminated with a plastic material (for example of polyethylene, polypropylene or polystyrene), a metal plate (for example aluminum, zinc or copper), a plastic film (for example cellulose diacetate, cellulose triacetate, cellulose propionate, cellulose butyrate, cellulose acetate butyrate, cellulose nitrate, polyethylene terephthalate, polyethylene, polystyrene, polypropylene, polycarbonate or polyvinylacetal), or paper or a plastic film laminated or evaporated with the aforementioned metal. A preferred support is a polyester film or an aluminum plate.

In case of using the image recording material based on the infrared sensitive composition of the invention for a printing plate precursor, it is preferred to use, as the support therefor, an aluminum plate which is light in weight and has excellent properties for surface treatment, in workability and in corrosion resistance. The aluminum material usable for such purpose can be, for example, a JIS 1050 material, a JIS 1100 material, a JIS 1070 material, an Al—Mg alloy, an Al—Mn alloy, an Al—Mn—Mg alloy, an Al—Zr alloy or an Al—Mg—Si alloy.

A preferred aluminum plate is a pure aluminum plate or an alloy plate principally composed of aluminum and containing another clement in a small amount, and can also be a plastic film on which aluminum is evaporated or laminated. The another element contained in the aluminum alloy may be silicon, iron, manganese, copper, magnesium, chromium, zinc, bismuth, nickel and/or titanium. The content of another element in the alloy is 10 wt. % or less. There is particularly preferred pure aluminum, but there may be used aluminum containing another element in a small amount since completely pure aluminum is difficult to produce in the refining technology. Thus, the aluminum plate employable in the invention is not specified in the composition thereof but there can be suitably utilized an aluminum plate of an already known and utilized material. A thickness of the aluminum plate to be employed in the invention is preferably about 0.1 mm to 0.6 mm, more preferably 0.15 mm to 0.4 mm, and particularly preferably 0.2 mm to 0.3 mm.

Prior to the surface roughening of the aluminum plate, there is conducted, if desired, a degreasing process for example with a surfactant, an organic solvent or an aqueous alkali solution, in order to remove rolling oil on the surface. The roughening process of the surface of the aluminum plate can be executed by various methods, for example a mechanical roughening method, a method of surface roughing by electrochemically dissolving the surface, or a method of selectively dissolving the surface chemically. For the mechanical method, there can be employed a known method such as a ball graining method, a brush graining method, a blast graining method or a buffing graining method. Also as the electrochemical roughing method, there is known a method utilizing an alternating current or a direct current in an electrolyte of hydrochloric acid or nitric acid.

Thus surface roughed aluminum plate is subjected, after alkali etching and neutralization if necessary, to an anodizing process, if desired, for improving a water holding property and an abrasion resistance of the surface. An amount of an anodic oxide film, formed by the anodizing, is preferably 1.0 g/m² or higher. In case the amount of the anodic oxide film is less than 1.0 g/m², there may result an insufficient press life or a tendency of generating scratches in a non-image portion in the use as the planographic printing plate, leading to so-called “scratch smear” which is caused by an ink deposition on such scratches at the printing operation. After the anodizing process, the aluminum is subjected to a process of rendering the surface thereof hydrophilic processing according to the necessity.

Such aluminum support may be subjected, after the anodizing process, to a treatement with an organic acid or a salt thereof, or to an application of an undercoat layer for the photosensitive layer to be coated.

Also an intermediate layer may be provided in order to improve the adhesion between the support and the photosensitive layer. For improving the adhesion, the intermediate layer is generally formed by a diazo resin or a phosphoric acid compound absorbable to the aluminum. A thickness of the intermediate layer can be arbitrarily selected but has to be such that a uniform bonding reaction can be caused with the upper photosensitive layer when exposed. In general a coating amount of about 1 to 100 mg/m² in dry solid is preferred, and a coating amount of 5 to 40 mg/m² is particularly preferred. A proportion of the diazo resin in the intermediate layer is in a range of 30 to 100%, preferably 60 to 100%.

After the surface of the support is subjected to a treatment or an undercoating as explained above, a back coating is provided on the rear surface of the support if necessary. Such back coating is preferably formed by a coated layer of an organic polymer compound described in JP-A No. 5-45885 or a metal oxide obtained by hydrolysis and polycondensation of an organic or inorganic metal compound described in JP-A No. 6-35174.

For a support of the planographic printing plate, there is preferred a center line average height of 0.10 to 1.2 μm. A roughness lower than 0.1 μm decreases the adhesion to the photosensitive layer, thus leading to a significant loss in the press life. Also a roughness higher than 1.2 μm increases occurrences of stains during the printing operation. Also the support has a color density in a range of 0.15 to 0.65 in reflection density. A density lighter than 0.15 causes an excessive halation at the image exposure, thus hindering the image formation, while a density darker than 0.65 renders the image not easily visible in a plate inspecting operation after the image development, thus significantly deteriorating the plate inspection property.

On the support obtained by the processes explained in the foregoing, there are formed the above-described photosensitive layer and other arbitrary layers such as a surface protective layer and a back coating layer to obtain a printing plate precursor having a negative image recording layer, utilizing the infrared sensitive composition of the invention. In the planographic printing plate of the invention, an image recording is executed with an infrared laser. It is also possible with an ultraviolet lamp or a thermal head such as a thermal recording. In the invention, there is preferably made an image exposure with a solid-state laser or a semiconductor laser emitting an infrared light of a wavelength from 760 nm to 1200 nm. The laser preferably has an output of 100 mW or higher, and a multi-beam laser device is preferably employed in order to shorten the exposure time. Also an exposure time per pixel is preferably 20 μsec or shorter. An exposure energy to the recording material is preferably within a range of 10 mJ/cm² to 300 mJ/cm². An excessively low exposure energy cannot cause a suffient hardening of the image recording layer, thereby being eventually unable to attain the dis solution rate defined in the invention. On the other hand, an excessively high exposure energy may cause a laser ablation in the image recording layer, thereby damaging the image.

Exposure in the invention is executed with an overlapping of a light beam of a light source. The overlapping means that a pitch of a sub scanning is smaller than a diameter of the light beam. Such overlapping can be quantitatively expressed, by representing the beam diameter by a width at a full width half maximum (FWHM), by FWHM/sub-scanning pitch (overlap coefficient). In the invention, the overlap coefficient is preferably 0.1 or higher.

A scanning method of the light source of an exposure apparatus to be employed in the invention is not particularly limited, and there can be employed for example an external drum scanning method, an internal drum scanning method or a flat bed scanning method. Also the light source can be of a single channel or multi channels, but multi-channel light sources are preferably employed in case of the external drum scanning method.

As a developer and a replenisher for the planographic printing plate utilizing the image recording material of the invention, there can be used an alkaline aqueous solution already known in the art.

For example, there can be employed an inorganic alkali salt such as sodium silicate, potassium silicate, trisodium phosphate, tripotassium phosphate, triammonium phosphate, disodium phosphate, dipotassium phosphate, diammonium phosphate, sodium carbonate, potassium carbonate, ammonium carbonate, sodium hydrogencarbonate, potassium hydrogencarbonate, ammonium hydrogencarbonate, sodium borate, potassium borate, ammonium borate, sodium hydroxide, ammonium hydroxide, potassium hydroxide or lithium hydroxide. Also there can be used an organic alkali compound such as monomethylamine, dimethylamine, trimethylamine, monoethylamine, diethylamine, triethylamine, monoisopropylamine, diisopropylamine, triisopropylamine, n-butylamine, monoethanolamine, diethanolamine, triethanolamine, minoisopropanolamine, diisopropanolamine, ethylenimine, ethylenediamine or pyridine. Such alikali compounds may be used singly or in a combination of two or more kinds.

A particularly preferred developer among these alkali compounds is an aqueous silicate solution such as of sodium silicate or potassium silicate. It is because the development performance can be regulated by the ratio and concentration of silicon oxide SiO₂, which is a component of the silicate and an alkali metal oxide M₂O, and alkali metal silicate salts as described in JP-A No. 54-62004 and JP-B No. 57-7427 can be effectively used.

Further, in case of a development with an automatic processor, it is already known that many presensitized plates can be developed without replacing the developer in a developing tank over a long period, by adding, to the developer, an aqueous solution with an alkalinity higher than that in the developer. Such replenishing method can be advantageously employed also in the invention. In the developer solution and the replenisher, various surfactants and organic solvents may be added according to the necessity, for the purpose of increasing or suppressing the development performance, dispersing development dregs and improving an ink affinity to an imaging portion of the printing plate.

A preferred surfactant can be an anionic, cationic, nonionic or amphoteric surfactant. Also if necessary, there may be added, to the developer and the replenisher, a reducing agent such as hydroquinone, resorcin, a sodium salt or a potassium salt of an inorganic acid such as sulfurous acid or hydrogensulfurous acid, an organic carboxylic acid, a antifoaming agent or a water softener.

The printing plate developed with aforementioned developer solution and replenisher is post-processed with washing, a rinse solution containing for example a surfactant, or a desensitizing solution including gum Arabic or a starch derivative. In case of using the image recording material of the invention as the planographic printing plate, these processes may be employed in various combinations as the post-processing.

An automatic processor is generally composed of a development unit and a post-process unit and is provided with an apparatus for conveying a printing plate, tanks for various solutions and a spraying apparatus, in which an exposed printing plate is subjected, while conveyed horizontally, to a development process by spraying various process solutions supplied by pumps from spray nozzles. Recently there is also known a method of processing by conveying a printing plate, for example by in-solution guide rollers, in a state immersed in a processing solution filled in a processing tank. In such automatic processing, the processing can be executed under a replenishment of a replenisher to each processing solution according to the processed quantity or the operation time. It is also possible to achieve an automatic replenishment, by means of detecting an electric conductivity by a sensor. Also there may be employed so-called disposable processing method in which the processing is executed with a substantially unused processing solution. The present invention, being free from concerns for a time-dependent loss of development performance resulting from carbon dioxide gas or a loss in the press life resulting from the developer, is advantageously applicable to any of these automatic processor.

The planographic printing plate thus obtained may be subjected to a printing process after coating, if desired, of a desensitizing gum, but a burning process is executed in case a longer press life is desired.

In case of burning a planographic printing plate, there is preferably executed, prior to the burning, a process with a plate burning conditioner as described in JP-B Nos. 61-2518 and 55-28062 and JP-A Nos. 62-31859 and 61-159655.

For such process, there can be employed a method of coating the plate burning conditioner on the planographic printing plate with a sponge or a cotton pad, immersing the printing plate in a vat filled with the plate burning conditioner, or coating with an automatic coater. Also a more preferable result can be provided by unifoeming the coating amount with a squeegee or a squeegee roller after the coating. The coating amount of the plate burning conditioner is generally within a range of 0.03 to 0.8 g/m² (dry weight).

The planographic printing plate coated with the plate burning conditioner is heated, after drying if necessary, to a high temperature by a burning processor (for example a burning processor “BP-1300” supplied by Fuji Photo Film Co., Ltd.). The temperature and time of heating in such operation depend on the kind of components constituting the image, but are preferably in ranges of 180 to 300° C. and 1 to 20 minutes.

The planographic printing plate after the burning process may be suitably subjected to conventional processes such as washing and gumming, but so-called desensitizing process such as gumming may be dispensed with in case a plate burning conditioner including a water soluble polymer compound is used.

The planographic printing plate in which the infrared sensitive composition of the invention is used for the image recording layer and which is obtained by such processes is used for example in an offset printing press and is used for printing a large number of prints.

### EXAMPLES

In the following, the present invention will be clarified in more details by examples thereof, but the scope of the invention is not limited by such examples.

### Examples 1-5,

### Comparative Examples 1, 2

Preparation of Aluminum Support

A molten metal of a JIS A1050 alloy, containing 99.5% or higher of aluminum, 0.30% of Fe, 0.10% of Si, 0.02% of Ti and 0.013% of Cu, was subjected to a purifying process and cast. The purifying process was conducted by a degassing in order to eliminate unnecessary gas such as hydrogen in the molten metal, and by a ceramic tuber filtration. The casting was conducted by a DC casting. A solidified ingot of a thickness of 500 mm was surfacially scraped off by 10 mm from the surface, and was subjected to a homogenization process for 10 hours at 550° C. in order to avoid rough growth of intermetallic compounds. It was then subjected to a hot rolling at 400° C., an intermediate annealing for 60 seconds at 500° C. in a continuous annealing furnace, and a cold rolling to obtain a rolled aluminum plate of a thickness of 0.3 mm. A roughness of rolling rollers was so controlled as to obtain a center line average height Ra of 0.2 μm after the cold rolling. Thereafter, a process by a tension leveler was executed in order to improve the flatness.

Then a surface treatment was conducted in order to obtain the support for the planographic printing plate.

The aluminum plate was at first subjected to a degreasing with a 10% aqueous solution of sodium aluminate for 30 seconds at 50° C. in order to remove the rolling oil on the surface, then neutralization with a 30% aqueous solution of sulfuric acid for 30 seconds at 50° C., to achieve desmutting.

Then there was conducted so-called graining, for making a rough surface on the support, in order to improve the adhesion between the support and the photosensitive layer and to provide a non-image portion with a water holding property. An aqueous solution containing nitric acid at 1% and aluminum nitrate at 0.5% was maintained at 45° C., and, while the aluminum web was carried in the aqueous solution, an electrolytic graining was executed by providing an anode-side electricity of 240 C/dm² from an indirect feed cell with an AC current of a current density of 20 A/dm² and a duty ratio 1:1. Then an etching was conducted with a 10% aqueous solution of sodium aluminate for 30 seconds at 50° C. and a neutralization was conducted with a 30% aqueous solution of sulfuric acid for 30 seconds at 50° C. to achieve desmutting.

Then an oxide film was formed on the support by anodizing, in order to improve the abrasion resistance, the chemical resistance and the water holding property. A 20% aqueous solution of sulfuric acid was employed at 35° C. as an electrolyte, and, while the aluminum plate was carried through the electrolyte, an electrolytic process was executed with a DC current of 14 A/dm² from an indirect feed cell thereby forming an anodic oxide film of 2.5 g/m². The support thus prepared had a center line average height Ra of 0.5 μm.

Photosensitive Layer

Then, a following photosensitive layer coating solution [P] was prepared, was coated with a wire bar on the aluminum plate subjected to the above-described surface treatment, and dried in a warm forced air drying equipment for 45 seconds at 115° C. to obtain negative printing plate precursor of Examples 1 to 5 and Comparative Examples 1 and 2, shown in Tab. 1. A coating amount after drying was within a range of 1.2 to 1.3 g/m².

Structures of an infrared absorber [IR-1] and an onium salt [OS-1] employed in the photosensitive layer coating solution are shown in the following.

<Photosensitive layer coating solution [P]>

| | |
|---|---|
| infrared absorber [IP-1] | 0.08 g |
| onium salt [OS-1] | (amount in Tab. 1) |
| dipentaerythritol hexaacrylate | (amount in Tab. 1) |
| allyl methacrylate-methacrylic acid | (amount in Tab. 1) |
| copolymer with a molar ratio 80:20 | |
| (weight-averaged molecular weight 120,000) | |
| naphthalenesulfonic acid salt of Victoria | 0.04 g |
| pure blue | |
| fluorochemical surfactant (Megafac F176; | 0.01 g |
| Dai-Nippon Ink and Chemical Industries, | |
| Co. Ltd.) | |
| stearoyl methylamide | 0.02 g |
| methylethylketone | 14.0 g |
| methanol | 6.5 g |
| 1-methoxy-2-propanol | 10.0 g |

IR-1

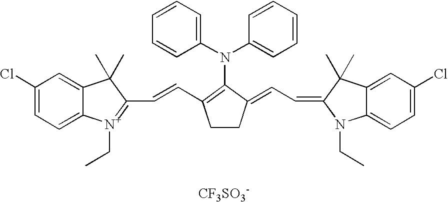

OS-1

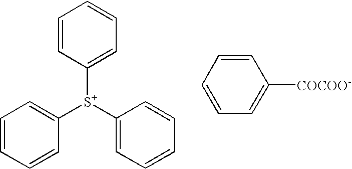

Exposure

The obtained negative printing plate precursor was exposed with a solid image and halftone dot images of 0.5% to 99.5%, on a Creo Trendsetter 3244VFS equipped with a 40 W water-cooled infrared semiconductor laser under conditions of an output of 9 W. an external drum revolution speed of 210 rpm, an energy of 100 mJ/cm² on the plate and a resolution of 175 lpi.

Insolubilization Rate

The exposed solid image was immersed in 1 liter of a mixed solvent of methylethyl ketone/dimethylsulfoxide (weight ratio 1/1) for 5 minutes at 25° C. and the weight change amount was measured. The weight change amount was similarly measured on an unexposed sample.

The insolubilization rate was determined by a percentage of [(weight change amount of before exposure)−(weight change amount of after exposure)]/(weight change amount of before exposure). The measurement results are shown in the following Table 1.

Development Process

The exposed halftone dot images were developed with an automatic processor LP-940H (manufactured by Fuji Photo Film Co., Ltd.). The employed developer was a DV-2 diluted to 1:17 with water (pH 11.1 at 25° C.). DV-2 is manufactured by Fuji Photo Film Co., Ltd. The replenisher was DV-2R manufactured by Fuji Photo Film Co., Ltd., diluted to 1:10. The developing bath was maintained at 30° C. For a finisher, there was employed FN-6 (diluted to 1:1 with water) manufactured by Fuji Photo Film Co., Ltd.

Evaluation of Dot Reproduction

The developed halftone dot images were evaluated according to the following 5 levels by observation under an optical microscope of a magnification of 100 times. Obtained results are shown in Table 1:

TABLE 1

| | Photosensitive Layer | | | | |
|---|---|---|---|---|---|
| | Coating Solution <P> | | | | |
| | | | Allyl Meth- | | |
| | | | acrylate-metha- | | |
| | Onium | Dipenta- | crylic Acid | Insolubi- | |
| | Salt | erythritol | Copolymer | lization | Dot |
| | (OS-1) | Hexaacrylate | (mol. ratio | Rate | Repro- |
| | (g) | (g) | 80:20) (g) | (%) | Duction |
| Example 1 | 0.10 | 1.00 | 1.00 | 30 | 3 |
| Example 2 | 0.20 | 1.00 | 1.00 | 40 | 4 |
| Example 3 | 0.40 | 1.00 | 1.00 | 50 | 4 |
| Example 4 | 0.20 | 0.5 | 1.5 | 50 | 4 |
| Example 5 | 0.40 | 0.5 | 1.5 | 60 | 5 |
| Comp. | 0.05 | 1.00 | 1.00 | 15 | 1 |
| Example 1 | | | | | |
| Comp. | 0.07 | 1.00 | 1.00 | 20 | 2 |
| Example 2 | | | | | |

5 0.5% to 99.5% faithfully reproduced
4 1% to 99% reproduced
3 2% to 98% reproduced, lower limit of acceptable range
2 3% to 98% reproduced, practically not acceptable
1 a level not reaching level 2.

As will be apparent from Table 1, the printing plate precursor of Examples 1 to 5, having the insolubilization rate in the specified organic solvent equal to or higher than 30%, are superior in the dot reproduction. These evaluations indicate that the insolubilization rate of the infrared sensitive composition is improved when the content of the onium salt, serving as the radical generating agent, is higher or when the content of the polymer having the polymerizable unsaturated group is higher.

### Examples 6, 7

The printing plate precursor of Examples 2 and 3 were subjected to an image formation with an exposure amount changed from 100 to 150 mJ/m² as shown in Table 2, and were evaluated as in Example 1. Obtained results are shown in Table 2.

TABLE 2

| | Exposure | Insolubilization | Dot |
|---|---|---|---|
| | (mJ/m²) | Rate (%) | Reproduction |
| Example 6 | 150 | 60 | 5 |
| Example 7 | 150 | 75 | 5 |

As will be apparent from Table 2, an increase in the exposure amount improved the insolubilization rate, with an improvement in the dot reproduction.

The present invention provides an infrared sensitive composition excellent in the image quality, particularly in the dot reproduction, and applicable to a negative image recording material which is capable of direct recording from digital data of a computer, by recording with a solid-state laser or a semiconductor laser emitting an infrared ray.

What is claimed is:

1. An infrared sensitive composition included in an image recording material comprising a support and a photosensitive layer disposed on the the support, the infrared sensitive composition being contained in the photosensitive layer, wherein after the photosensitive layer has been formed and the infrared sensitive composition is exposed to an infrared laser, the infrared sensitive composition has an insolubilization rate within a range of 30% to 100% with respect to a mixed organic solvent containing methylethyl ketone and dimethyl-sulfoxide in a ratio of 1:1.

2. An infrared sensitive composition according to claim 1, wherein the insolubilization rate is within a range of 35% to 100%.

3. An infrared sensitive composition according to claim 1, wherein the insolubilization rate is within a range of 60% to 100%.

4. An infrared sensitive composition according to claim 1, wherein the photosensitive layer exposed to the infrared laser is hardened only in an upper layer portion thereof.

5. An infrared sensitive composition according to claim 1, further comprising an infrared absorber, wherein the infrared absorber is at least one selected from the group consisting of dyes and pigments having an absorption maximum within a wavelength range of 760 nm to 1200 nm.

6. An infrared sensitive composition according to claim 5, wherein the infrared absorber is a dye including a compound represented by the following general formula (I): 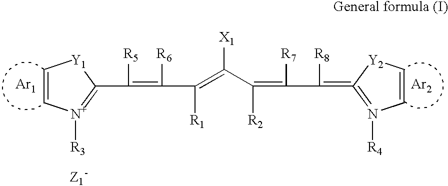
wherein X₁ represents a halogen atom or X₂-L₁ in which X₂ represents an oxygen atom or a sulfur atom and L₁ represents a hydrocarbon group having 1 to 12 carbon atoms; R₁ and R₂ each independently represent a hydrocarbon group having 1 to 12 carbon atoms; Ar₁ and Ar₂ each independently represent an aromatic hydrocarbon group which may have a substituent; Y₁ and Y₂ each independently represent a sulfur atom or a dialkylmethylene group having 12 or less carbon atoms; R₃ and R₄ each independently represent a hydrocarbon group having 20 or less carbon atoms which may have a substituent; R₅, R₆, R₇ and R₈ each independently represent a hydrogen atom or a hydrocarbon group having 12 or less carbon atoms; and Z₁⁻ represents a counter anion but may be dispensed with if any of R₁ to R₈ has a sulfo group as a substituent.

7. An infrared sensitive composition according to claim 5, wherein the photosensitive layer including the infrared absorber has an optical density within a range of 0.1 to 3.0 at an absorption maximum within a wavelength range of 760 nm to 1200 nm.

8. An infrared sensitive composition according to claim 1, further comprising an onium salt.

9. An infrared sensitive composition according to claim 8, wherein the onium salt is at least one compound selected from the group of compounds represented by the following general formulae (III) to (V):
Ar₁₁—I⁺—Ar₁₂Z₁₁⁻ (General formula III)
Ar₂₁—N⁺≡N⁺Z₂₁⁻ General formula (IV) 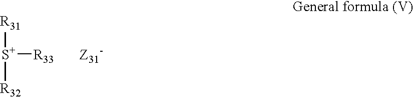
wherein, in the formula (III), Ar₁₁ and Ar₁₂ each independently represent an aryl group having 20 or less carbon atoms which may have a substitutent; and Z₁₁⁻ represents a counter ion selected from the group consisting of a halogen ion, a perchlorate ion, a tetrafluoroborate ion, a hexafluorophosphate ion, a carboxylate ion and a sulfonate ion;
in the formula (IV), Ar₂₁ represents an aryl group having 20 or less carbon atoms which may have a substituent; and Z₂₁⁻ represents a counter ion of the same definition as Z₁₁⁻; and
in the formula (V), R₃₁, R₃₂ and R₃₃ each independently represent a hydrocarbon group having 20 or less carbon atoms which may have a substituent; and Z₃₁⁻ represents a counter ion of the same definition as Z₁₁⁻.

10. An infrared sensitive composition according to claim 8, wherein the photosensitive layer is formed by coating a photosensitive layer coating solution including the infrared sensitive composition, and the onium salt is contained in an amount of 0.1% to 50% by weight with respect to a total solid content of the photosensitive layer coating solution.

11. An infrared sensitive composition according to claim 8, wherein the photosensitive layer is formed by coating a photosensitive layer coating solution including the infrared sensitive composition, and the onium salt is contained in an amount of 1% to 20% by weight with respect to a total solid content of the photosensitive layer coating solution.

12. An infrared sensitive composition according to claim 1, further comprising a compound containing at least one ethylenic unsaturated double bond.

13. An infrared sensitive composition according to claim 1, further comprising a compound containing two or more terminal ethylenic unsaturated double bonds.

14. An infrared sensitive composition according to claim 1, wherein the infrared laser is at least one of a solid-state laser and a semiconductor laser, emitting light within a wavelength range of 760 nm to 1200 nm.

15. An infrared sensitive composition according to claim 1, wherein an amount of exposure by the infrared laser is within a range of 10 mJ/cm² to 300 mJ/cm².

16. An infrared sensitive composition according to claim 1, further comprising a linear organic polymer.

17. An infrared sensitive composition according to claim 16, wherein the linear organic polymer is at least one selected from the group consisting of a polymer soluble in water, a polymer soluble in alkalescent water, a polymer swellable in water and a polymer swellable in alkalescent water.

18. An infrared sensitive composition according to claim 16, wherein the linear organic polymer has a weight-average molecular weight within a range of 10,000 to 300,000.

19. An infrared sensitive composition according to claim 16, wherein the linear organic polymer is a random polymer.

20. An infrared sensitive composition according to claim 1, further comprising an unsaturated bond-containing compound including at least one ethylenic unsaturated double bond, and a linear organic polymer, wherein a ratio (b/a) of a weight of the added unsaturated bond-containing compound (b) to a weight of the linear organic polymer (a) is within a range of 1/9 to 7/3.
